(19) United States
(12) Patent Application Publication
(10) Pub. No.: US 2015/0021858 A1
(43) Pub. Date: Jan. 22, 2015

(54) BULKHEAD SEALING ASSEMBLY

(71) Applicant: Halla Visteon Climate Control Corp., Daejeon (KR)

(72) Inventors: Gerald Richter, Aachen (DE); Gerd Vondahlen, Gangelt (DE); Johannes Stausberg, Köln (DE); Ralph Wiesmann, Weilerswist (DE); Thomas Alberternst, Aachen (DE)

(21) Appl. No.: 14/333,882

(22) Filed: Jul. 17, 2014

(30) Foreign Application Priority Data
Jul. 17, 2013 (DE) 102013107601.7

(51) Int. Cl. F16L 5/02; B62D 25/16

(52) U.S. Cl. CPC F16L 5/02; B62D 25/16
USPC 277/314; 277/606

(57) ABSTRACT

Disclosed herein is a bulkhead sealing assembly including, a sealing-function group having a base plate, an outer sealing portion, and at least one inner sealing portion. The bulkhead sealing assembly further includes an elastic tolerance compensation member and a receiving memberformed as a flange surface of a housing of a vehicle air-conditioning system. The bulkhead sealing assembly has a tolerance compensation function for at least one connector through-portion which penetrates a vehicle bulkhead.

### CROSS-REFERENCE TO RELATED APPLICATION

This application claims priority to German Patent Application No. 102013107601.7, filed on Jul. 17, 2013, the disclosure of which is incorporated herein by reference in its entirety.

### FIELD OF THE INVENTION

Exemplary embodiments of the present invention relate to a bulkhead sealing assembly having a tolerance compensation function for a vehicle air-conditioning system in order to seal a connector through-opening which penetrates a bulkhead between a passenger compartment and an engine room of a vehicle.

### BACKGROUND OF THE INVENTION

An air-conditioning system for a vehicle requires a connector for transporting a heat exchanger fluid between an interior and an engine room of the vehicle. In a region of the connector, a bulkhead sealing assembly seals a through-opening to prevent splash water, for example. On the one hand, such sealing assemblies should be designed to have water tightness and air tightness. On the other hand, such sealing assemblies should have a design structure capable of basically compensating for a tolerance generated in a body-in-white and a tolerance caused by tolerance chains between groups composed of mounted parts, in connection with devices mounted around a cockpit of the vehicle. In addition, the sealing assemblies should contribute to sufficiently reduce acoustic coupling of a passenger compartment and the engine room.

For such sealing, so-called rubber grommets, which have a high tolerance compensation function to ensure watertight sealing, such as rubber tubular members, which are specially formed, are currently used. These rubber grommets are fixed, on the one hand, into the air-conditioning system, and are fixed, on the other hand, into a vehicle body structure. Alternatively, foamed sealing assemblies are used and also seal connectors for air-conditioning systems toward a bulkhead. Foam strips are modified examples of another known sealing assembly. For instance, the foam strips are sealing assemblies which are die-cut from a PUR (polyurethane) foam mat provided on the air-conditioning system.

When the conventional rubber grommets are used, there are disadvantages of using costly grommets and having a complicated assembly process. For example, a complicated assembly process can be a process of connecting the rubber grommets to the vehicle body. In addition, it is a disadvantage that process reliability is not always ensured during assembly.

Similarly, when the foamed sealing assemblies are used, it is costly in manufacture thereof and many efforts are required to assemble them in order to achieve previous compression of the sealing assemblies. When the foam strips or the die-cut sealing assemblies are used, they may merely realize low tolerance compensation properties or may not sufficiently reduce acoustic coupling of components. Particularly, a bulkhead insulating portion, which serves as an insulating layer of a felt type and may be formed on a bulkhead at a passenger compartment of the vehicle, may restrictively function merely as a covering due to a single layer foam-stamping part.

Besides the above typical sealing technologies, technical measures including a two-component manufacturing method (a so-called 2C manufacturing method) are also known. In this way, different materials may be alloyed as one part. In this case, hard-soft compounds may also be used and combined. Plastic parts composed of a plurality of components may be produced by only one injection molding process through the two-component manufacturing method. The two-component manufacturing method may save resources and reduce time and costs since it fully eliminates a complicated process of manually assembling parts which are individually injection-molded.

German Pat. Appl. Pub. No. DE 102009056043 A1 discloses a sealing assembly composed of two different soft components. The sealing assembly has an outer edge component which is made of foamed plastic or synthetic resin, particularly PUR, and surrounds the circumference thereof, and an inner sealing component made of a rubber material, particularly EPDM (Ethylene-Propylene-Diene-Rubber). All through-openings for heating pipes or air-conditioning pipes are provided on the inner sealing component connected to the outer edge component in a manner of coupling shapes and materials by bellows.

European Pat. No. EP 1700723 B1 discloses a two-component sealing assembly which has a sealing member made of an elastomeric material and a reinforcement member made of a hard plastic material. In this case, the sealing member is formed on the reinforcement member by two-component injection molding and two components are connected by the bellows.

European Pat. Appl. Pub. No. EP 1512614 A1 discloses a two-component sealing assembly which has a self-supported main body and at least one flexible sealing portion. In this case, the sealing assembly is manufactured by multicomponent injection molding. The sealing assembly has specialty in terms of being formed as a self-supported part or formed with a replaceable bezel made of a soft material.

The related art has a disadvantage in that the different bulkhead sealing assemblies having the bellows and the replaceable members are a complicated design structure. For this reason, the bulkhead sealing assemblies may lead to excess costs in manufacture thereof and may be damaged during assembly and insertion thereof.

### SUMMARY OF THE INVENTION

An object of the present invention is to provide an economical bulkhead sealing assembly capable of being easily manufactured and assembled, maintaining solidity during an insertion process, realizing high tolerance compensation properties between groups composed of adjacent parts, significantly reducing vibration and engine noise, and having high water tightness and air tightness.

The objects and advantages of the present invention can be resolved by the bulkhead sealing assembly having characteristics of claim 1 and improved embodiments of the bulkhead sealing assembly are disclosed in dependent claims. Also, it is obvious to those skilled in the art to which the present invention pertains that the objects and advantages of the present invention can be realized by the means as claimed and combinations thereof.

In accordance with one aspect of the present invention, a bulkhead sealing assembly includes a sealing-function group, an elastic tolerance compensation member, and a receiving member for receiving a flange surface of a housing of an air-conditioning system. The bulkhead sealing assembly has a tolerance compensation function for at least one connector through-portion which penetrates a vehicle bulkhead. The sealing-function group includes a base plate, an outer sealing portion, and at least one inner sealing portion, in order to seal connectors.

The outer sealing portion surrounds an outer edge of the base plate and seals the base plate toward the vehicle bulkhead. The inner sealing portions having an expansion valve sealing portion of the vehicle air-conditioning system and connector sealing portions seal a receiving plate or the base plate for the connectors.

One of the connectors is preferably formed as an expansion valve of the vehicle air-conditioning system, which is wholly received by an opening on the base plate together with a protrusion portion and the expansion valve sealing portion and by a shape coupling method. As described later, the protrusion portion may be a type in which the edge of the base plate extends outwards from a surface of the base plate by turning around an expansion valve opening.

In an embodiment, since all components of the bulkhead sealing assembly, namely a hard receiving plate, a soft tolerance compensation member, and soft inner and outer sealing portions are individually and fully manufactured by multicomponent injection molding, the bulkhead sealing assembly may be integrally formed.

The present invention compounds merits of a significantly reduced material cost and assembly cost, while having a solid structure by a two-component manufacturing method or a similar multicomponent manufacturing method. Furthermore, the sealing portions, which are extrusion coated, provide sufficient air tightness and water tightness against gas and splash water, in connection with high tolerance compensation properties.

In various embodiments, functional groups of the bulkhead sealing assembly are preferably combined with each other. For example, it is particularly preferable that functions of the tolerance compensation member and the sealing-function group are formed in a combined form. In this embodiment, the tolerance compensation member is realized as a necessary component of the base plate. In this case, the base plate includes a spring-loaded plastic member of an elastic fold type, capable of accomplishing force build-up. In this case, the soft component may be used in an auxiliary form. In addition, it is particularly preferable that functions of the receiving member and the tolerance compensation member are formed in a combined form. In this embodiment, the tolerance compensation member also performs a receiving function for the air-conditioning system, as well as a tolerance compensation function.

In a further preferable embodiment, the receiving member is decreased to be adapted for an effective area within the sealing-function group and is formed as a portion of the base plate. In this case, the receiving member has an effect in that the receiving member is disposed on the flange surface of the housing of the air-conditioning system by a suitable fixing means.

The tolerance compensation member is manufactured by an elastic material or is formed of a spring-loaded member. The elastic material or the spring-loaded member flexibly connects the receiving member to the sealing-function group. According to a simple and preferable example of the present invention, the tolerance compensation member is realized by a single layer or multilayer foam material, a plastic spring, or an elastic fold.

The present invention is preferably improved by forming the outer sealing portion of the vehicle bulkhead as a foam strip. In a particularly preferable example, the inner sealing portions are geometrically formed as a grommet. In this case, due to the above concept, tubular members, which are specially formed, particularly are gradually tapered in a truncated form, are provided, and the tubular members are attached to openings of a body.

In addition, the sealing-function group preferably includes an additional sealing portion in addition to the inner and outer sealing portions. For example, the additional sealing portion includes a so-called rear sealing portion or an alternative side sealing portion, at the passenger compartment. The two modified sealing portions seal the base plate with respect to the bulkhead insulating portion. The two modified sealing portions are distinguished from each other in that the rear sealing portion is disposed on a surface allocated to the vehicle air-conditioning system, whereas the side sealing portion is formed on the outer edge of the bulkhead sealing assembly.

Subsequently, the present invention is realized in a such a way that the rear sealing portion is formed as a foam strip, or the side sealing portion is formed as a sealing portion which is extrusion coated by the two-component manufacturing method along the side edge of the base plate and is designed in a manner of overlapping with a vehicle-mounted bulkhead insulating portion.

The two alternative sealing portions are an additional sealing lip for reducing a level of noise generated by an engine room. The different sealing portions also reduce vibration. Otherwise, the sealing portions transfer the vibration from the engine room to a dashboard through connection ports of the air-conditioning system. Finally, due to such a design, the present invention expands a tolerance range even when force related to assembly and contact pressure during assembly of the air-conditioning system is lowered.

In a particularly preferable example, the sealing portions of the sealing-function group are formed from an elastomeric material. According to a simple and preferable example of the present invention, the base plate is formed from polyolefin, for example polypropylene containing fillers such as talc or glass fiber. The outer and inner sealing portions are formed from TPE (Thermal Plastic Elastomer) or are respectively formed from different materials. For example, the thermal plastic elastomer SEBS (Styrene-Ethylene-Butylene- Styrene) has lower hardness and high bonding force to a base plate material, with the consequence that thermal plastic machining may be easily performed.

In the way that the rear sealing portion is formed as a die cut plate from a PUR (polyurethane) foam material having a single or double skin as occasion demands, this is suitable and a preferable combination for the purpose of the present invention. When such a material is bonded below the receiving member, the receiving member performs a tolerance function and is formed as open-celled form while having corresponding compression hardness.

In an example related to the passenger compartment, the bulkhead sealing assembly is preferably fixed to the vehicle bulkhead by fixing members such as screws. Thus, relatively thin sealing members may be used in the bulkhead. Since the bulkhead sealing assembly for the housing the air-conditioning system may be formed so as to be restrictively movable, it may be possible to reduce acoustic coupling of the air-conditioning system and the vehicle body.

During assembly of the air-conditioning system, the bulkhead sealing assembly is designed such that contact force applied to the bulkhead is sufficiently maintained but reaction force against the air-conditioning system is weakly maintained. Due to such a design, it may be possible to assemble the air-conditioning system without an additional coupling process.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a top view schematically illustrating a bulkhead sealing assembly;

FIG. 2 is a schematic cross-sectional view of the bulkhead sealing assembly taken along line X-X of FIG. 1;

FIG. 3A is a view schematically illustrating the bulkhead sealing assembly having a rear sealing portion;

FIG. 3B is a view schematically illustrating the bulkhead sealing assembly having a side sealing portion;

FIG. 3C is a view schematically illustrating the bulkhead sealing assembly having the rear sealing portion and shows a combination of functional groups configured of a tolerance compensation member and a receiving member;

FIG. 4A is a top view schematically illustrating the bulkhead sealing assembly having the tolerance compensation member incorporated in a sealing-function group; and

FIG. 4B is a schematic cross-sectional view of the bulkhead sealing assembly taken along line Y-Y of FIG. 4A.

### DETAILED DESCRIPTION OF EXEMPLARY EMBODIMENTS OF THE INVENTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. The drawings are not necessarily to scale and in some instances, proportions may have been exaggerated in order to clearly illustrate features of the embodiments.

A bulkhead sealing assembly may be generally represented as a flat plate disposed between a vehicle air-conditioning system and a bulkhead (in other words, a wall between an interior and an engine room in a vehicle) in a passenger compartment of a vehicle. Accordingly, the bulkhead sealing assembly has a surface allocated to the bulkhead indicative of the bulkhead side and a surface allocated to the vehicle air-conditioning system indicative of the passenger compartment side.

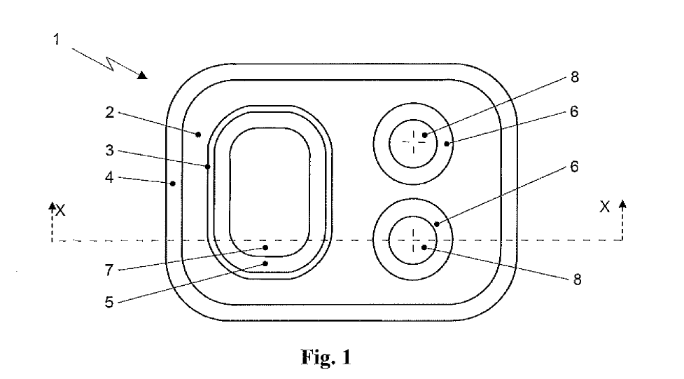

FIG. 1 shows a bulkhead side top view schematically illustrating a bulkhead sealing assembly 1 which includes a base plate 2 made of hard plastic for sealing of connectors, an outer sealing portion 4 surrounding a circumference of the base plate, and at least one inner sealing portion 5 or 6. An opening 7, for receiving an expansion valve, is located on the base plate 2 as occasion demands. In this case, at the bulkhead side, a protrusion portion 3 of the base plate 2 is formed around the opening. The protrusion portion 3 together with the sealing portion 5 wholly receives the expansion valve inserted into the passenger compartment by a shape coupling method. In this case, the sealing portion 5, formed as a grommet, seals the bulkhead sealing assembly I toward the expansion valve.

In addition, at least one opening 8, for receiving a connector of the vehicle air-conditioning system, is located on the base plate 2. In this case, at the bulkhead side, the sealing portion 6 surrounding a circumference of each opening 8 is formed as a grommet on the base plate 2. The sealing portion 6 individually seals the bulkhead sealing assembly 1 toward each connector.

Finally, at the bulkhead side, the outer sealing portion 4 surrounding the circumference of the base plate 2 is disposed on an edge region of the base plate 2. The outer sealing portion 4 seals the bulkhead sealing assembly 1 toward the vehicle bulkhead.

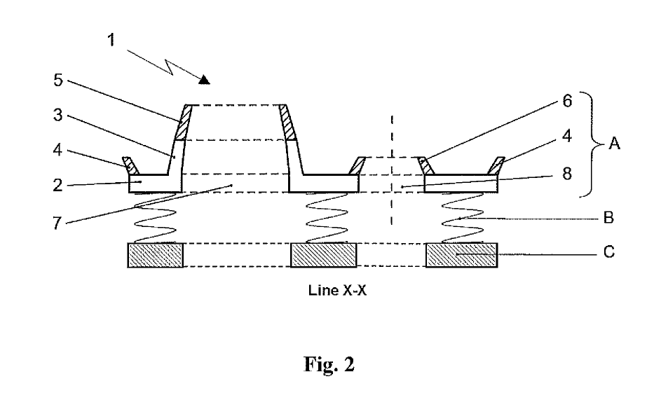

FIG. 2 is a schematic cross-sectional view of the bulkhead sealing assembly 1 taken along line X-X of FIG. 1. In this case, an upper surface is set toward the bulkhead and a lower surface is set toward the air-conditioning system at the passenger compartment. FIG. 2 shows a sealing-function group A, a tolerance compensation member B shown as a spring, and a receiving member C having openings corresponding thereto. If the air-conditioning system having the expansion valve is designed, the protrusion portion 3 for receiving the expansion valve is preferably formed on the base plate 2 around the opening 7, at the bulkhead side. This is because the expansion valve of the air-conditioning system is generally disposed outside a housing of the air-conditioning system.

At the bulkhead side, the sealing portions 4, 5, and 6, which are extrusion coated on the base plate 2 by a two-component manufacturing method, are attached to an outer edge of the base plate 2 and inner edges around the openings 7 and 8. In this case, the inner sealing portions 5 and 6 are formed as a grommet and protrude inward of the associated openings 7 and 8 from the edge of the base plate 2 at a side surface thereof.

It is seen that the sealing portions 4, 5, and 6 having a large width are actually preferable in terms of ensuring high tolerance compensation properties between parts. Thus, due to the high tolerance compensation properties, it may be possible to sufficiently reduce acoustic coupling of adjacent components.

The bulkhead sealing assembly 1 has the tolerance compensation member B designed as a spring member which presses the sealing-function group A to a vehicle bulkhead 11, at the passenger compartment. The spring member may be a component of the bulkhead sealing assembly 1 or a separate part. In addition, the receiving member C fixed to the bulkhead sealing assembly may be designed as a separate member as shown in FIG. 2 or may be considered as an effective area within the sealing-function group A.

The two-component manufacturing method has specialty in that the bulkhead sealing assembly 1 is integrally formed. Thus, it may be possible to fully eliminate a complicated process of manually assembling the separate molded parts. Furthermore, the bulkhead sealing assembly 1 may obtain improvements without a design of complicated shapes such as bellows or replaceable parts, and thus may achieve a cost reduction and simplification of assembly and beneficially affect lifespan of parts.

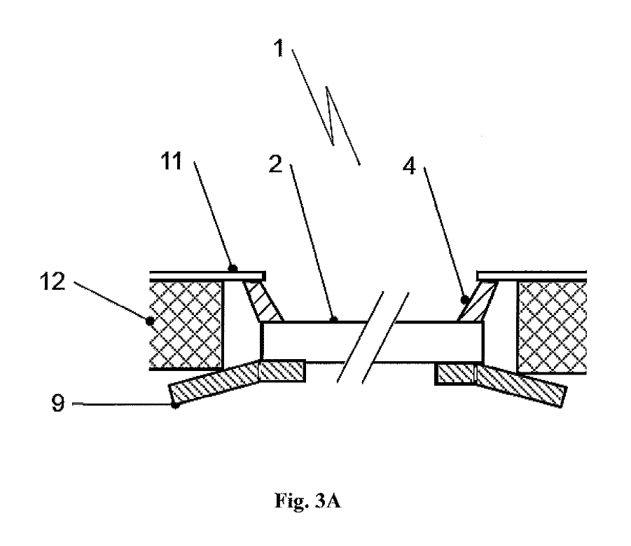

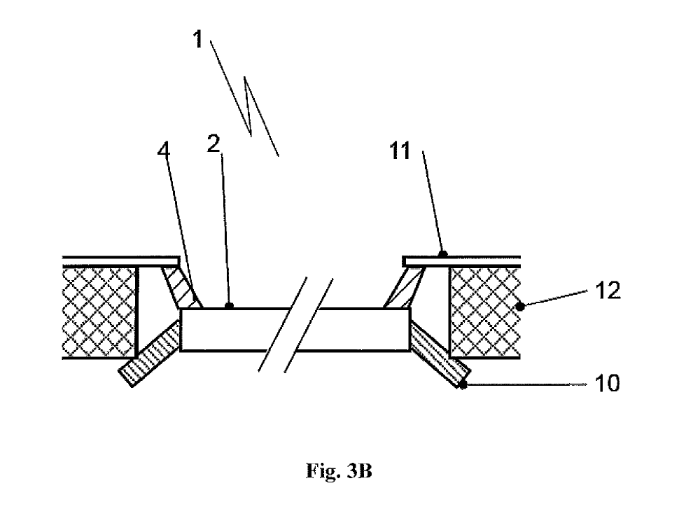

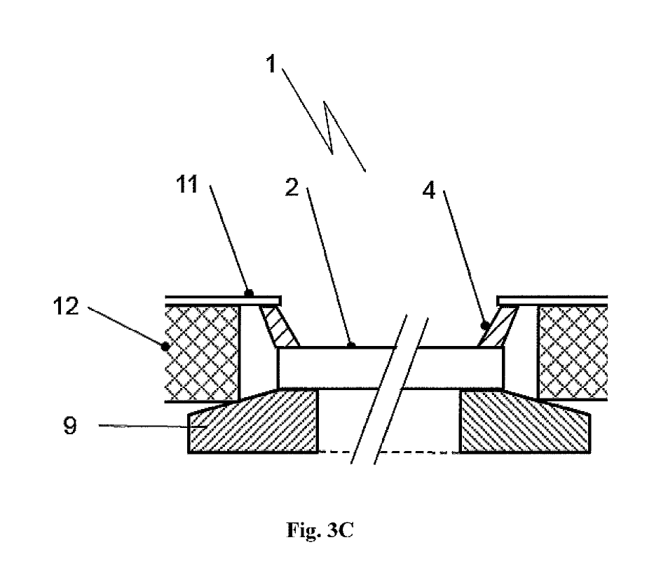

FIGS. 3A, 3B, and 3C are views schematically illustrating the edge of the bulkhead sealing assembly 1 and various modified design examples of a rear sealing portion 9 and a side sealing portion 10. The bulkhead sealing assembly 1 is disposed in an assembled state in front of the vehicle bulkhead 11 and within a recess of a bulkhead insulating portion 12. The vehicle air-conditioning system to be located below the base plate 2 in the passenger compartment, namely in the drawings of FIGS. 3A, 3B, and 3C, are not shown in the drawings.

In the embodiment shown in FIG. 3A, the rear sealing portion 9 is fixed onto the base plate 2 at the passenger compartment, namely toward the air-conditioning system. In this case, the rear sealing portion 9 is formed as a foam strip to increase tolerance compensation properties. FIG. 3A shows an overlap between the rear sealing portion 9 and the bulkhead insulating portion 12.

FIG. 3B shows an alternative embodiment. In the alternative embodiment, a sealing lip as the side sealing portion 10 is splashed along a side edge of the base plate 2 in a manner of overlapping with the bulkhead insulating portion 12 at the passenger compartment manufactured by the two-component manufacturing technique, thereby helping to reduce noise generated by the engine room. The outer sealing portion 4 previously ensures that the engine room is sufficiently sealed with water tightness and air tightness so as to block gas and splash water from the passenger compartment. The outer sealing portion 4 is preferably pressed to the vehicle bulkhead 11 through a screw connection. In the two embodiments, the receiving member C is shown as a necessary component of the base plate 2 without a special design.

FIG. 3C shows an embodiment in which the receiving member C is incorporated in the rear sealing portion 9. Moreover, the sealing portion 9 is designed as a single layer or multilayer foam part forming an overlap with the bulkhead insulating portion 12, similarly to a case of FIG. 3A. Furthermore, the rear sealing portion 9 has a thicker thickness and is more stably designed, compared to a case of FIG. 3A. As a result, the rear sealing portion 9 also serves as the receiving member C and provides a flange surface in the housing of the air-conditioning system.

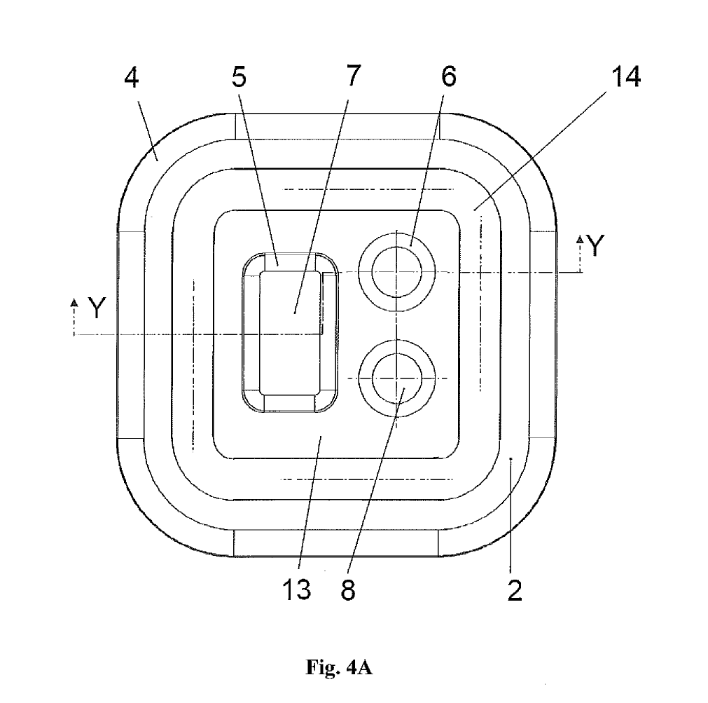

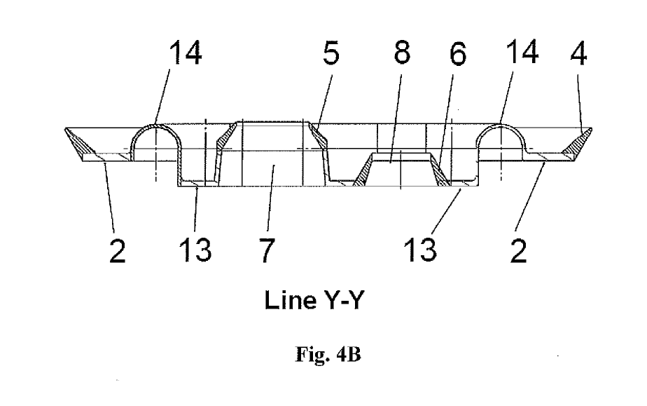

FIG. 4A shows an alternative example of the bulkhead sealing assembly 1. In this case, a base plate 2 is expanded so as to surround an elastic tolerance compensation member B, compared to the base plate of FIG. 1. The tolerance compensation member B is formed as a ring type elastic fold 14 which further subdivides the base plate 2 and separates an inner portion of the base plate as a receiving member C. In the modified design example, the receiving member C is formed as a receiving plate 13. An outer sealing portion 4 is disposed on an outer edge of the base plate 2, whereas an expansion valve opening 7 and a connector opening 8 together with associated sealing portions are located on the inner receiving plate 13.

FIG. 4B is a design cross-sectional view of the bulkhead sealing assembly 1 taken along line Y-Y of FIG. 4A. In the modified design example, the tolerance compensation member B is designed as a portion of the sealing-function group A. The receiving plate 13 is displaced from a position of an elastic fold 14 opposite to the base plate 2 at the passenger compartment. As a result, the receiving plate 13 is disposed immediately in the rear of the vehicle air-conditioning system. In the cross-sectional view, the tolerance compensation member B is formed in the form of the elastic fold 14. The base plate 2 is pressed toward the vehicle bulkhead II by stress of the tolerance compensation member B, and thus the receiving plate 13 is pressed toward the vehicle air-conditioning system.

In the various modified design examples shown in the drawings, the rear sealing portions 9 and side sealing portions 10, which may be additionally disposed on the base plate 2 at the passenger compartment, are not shown in the FIG. 4B.

While the present invention has been described with respect to the specific embodiments, it will be apparent to those skilled in the art that various changes and modifications may be made without departing from the spirit and scope of the invention as defined in the following claims.

What is claimed is:

1. A bulkhead sealing assembly for a vehicle comprising:
a sealing-function group having a base plate, an outer sealing portion, and at least one inner sealing portion;
a tolerance compensation member urging the sealing-function group towards a vehicle bulkhead; and
a receiving member one of coupled to the sealing-function group and integrally formed with the sealing-function group, the receiving member configured to be disposed on a flange surface of a housing of a vehicle air-conditioning system, wherein the sealing function group, the elastic tolerance compensation member, and the receiving member cooperate with each other to seal a through-opening of the vehicle bulkhead for receiving at least a connector of the vehicle air-conditioning system and provide a tolerance compensation function for the connector.

2. The bulkhead sealing assembly according to claim 1, wherein the sealing-function group, the tolerance compensation member, and the receiving member are at least one of integrally formed with each other and formed by multicomponent injection molding.

3. The bulkhead sealing assembly according to claim 1, wherein the tolerance compensation member is integrally formed with at least one of the sealing-function group and the receiving member.

4. The bulkhead sealing assembly according to claim 1, wherein the receiving member forms a portion of the base plate.

5. The bulkhead sealing assembly according to claim 1, wherein the tolerance compensation member is formed from one of a single layer foam material and a multilayer foam material.

6. The bulkhead sealing assembly according to claim 1, wherein the tolerance compensation member is one of a plastic spring, an elastic fold, and a foam strip.

7. The bulkhead sealing assembly according to claim 1, wherein the at least one inner sealing portion is a grommet.

8. The bulkhead sealing assembly according to claim 1, wherein the sealing-function group includes a rear sealing portion disposed on the base plate and overlapping a bulkhead insulating portion of the vehicle bulkhead.

9. The bulkhead sealing assembly according to claim 8, wherein the rear sealing portion is at least one of a foam strip and formed from a polyurethane foam material.

10. The bulkhead sealing assembly according to claim 1, wherein the sealing-function group includes a side sealing portion disposed on the base plate and overlapping a bulkhead insulating portion of the vehicle bulkhead, wherein the sealing portion is extrusion coated by a two-component manufacturing method.

11. The bulkhead sealing assembly according to Claim I, wherein the outer sealing portion and the at least one inner sealing portion are formed from an elastomeric material,

12. The bulkhead sealing assembly according to claim 1, wherein the base plate is formed from a polyolefin.

13. The bulkhead sealing assembly according to claim 1, wherein the outer sealing portion and the at least one inner sealing portion are formed from a thermal plastic elastomer.

14. The bulkhead sealing assembly according to claim 1, wherein the outer sealing portion is formed from a material different from a material forming the at least one inner sealing portion.

15. The bulkhead sealing assembly according to claim 1, further comprising a first opening formed in the base plate, a second opening formed in the base plate, and a protrusion portion extending outwardly from the base plate and surrounding the first opening.

16. A bulkhead sealing assembly for a vehicle comprising:
a base plate having a first opening and at least one second opening formed therein, the first opening configured for receiving an expansion valve of a vehicle air-conditioning system and the second opening configured for receiving a connector of the vehicle air-conditioning system;
at least one inner sealing portion disposed on the base plate surrounding at least one of the first opening and the second opening;
an outer sealing portion circumferentially surrounding at least a portion of the base plate; and
a tolerance compensation member one of integrally formed with and coupled to the base plate, the tolerance compensation member urging the base plate towards a vehicle bulkhead; and
a receiving member one of coupled to the sealing-function group and integrally formed with the sealing-function group, the receiving member configured to be disposed on a flange surface of a housing of the vehicle air-conditioning system.

17. The bulkhead sealing assembly according to claim 16, further comprising a protrusion portion extending outwardly from the base plate and surrounding the first opening.

18. The bulkhead sealing assembly according to claim 16, further comprising one of a rear sealing portion and a side sealing portion, the rear sealing portion disposed on a surface of the base plate and configured to overlap a bulkhead insulating portion of the vehicle bulkhead, the side sealing portion disposed on a side edge of the base plate and configured to overlap the bulkhead insulating portion of the vehicle bulkhead.

19. The bulkhead sealing assembly according to claim 16, wherein the base plate, the at least one inner sealing portion, and the outer sealing portion form a sealing-function group, wherein the sealing-function group, the tolerance compensation member, and the receiving member are at least one of integrally formed with each other and formed by multicomponent injection molding.

20. A method of sealing a vehicle bulkhead comprising the steps of:
providing a vehicle bulkhead defining a through-opening for receiving at least a connector of a vehicle air-conditioning system;
providing a bulkhead sealing assembly including a sealing-function group having a base plate, an outer sealing portion, and at least one inner sealing portion, a tolerance compensation member, and a receiving member one of coupled to the sealing-function group and integrally formed with the sealing-function group;
sealing the through-opening with the bulkhead sealing assembly; and
urging the sealing function group towards the vehicle bulkhead by at least the tolerance compensation member to facilitate sealing the through-opening.
